(19) United States
(12) Patent Application Publication
(10) Pub. No.: US 2014/0348500 A1
(43) Pub. Date: Nov. 27, 2014

(54) OPTICAL RECEIVER AND SLICE LEVEL CONTROL METHOD

(71) Applicant: Fujitsu Optical Components Limited, Kawasaki-shi (JP)

(72) Inventor: Toshio ISHII, Yokohama (JP)

(73) Assignee: Fujitsu Optical Components Limited, Kawasaki-shi (JP)

(21) Appl. No.: 14/258,287

(22) Filed: Apr. 22, 2014

(30) Foreign Application Priority Data
May 21, 2013 (JP) 2013-107502

(51) Int. Cl. H04B 10/079; H04B 10/40; H04B 10/60

(52) U.S. Cl. CPC H04B 10/07953; H04B 10/60; H04B 10/40
USPC 398/27

(57) ABSTRACT

An optical receiver includes a first discriminator in which an optimal point of a slice level is set and that compares a received signal to the slice level and discriminately outputs the received signal; a second discriminator that is connected in parallel to the first discriminator, compares the received signal to a slice level, and discriminately outputs the received signal; and a computing device that variably controls the slice level of the first and the second discriminators, respectively. The computing device executes a first process of setting the slice level of the first discriminator to be a predetermined slice level, calculating a pseudo error rate obtained when the slice level of the second discriminator is caused to variably scan, and setting the slice level of the first discriminator within a range in which the error rate does not vary.

### CROSS REFERENCE TO RELATED APPLICATIONS

This application is based upon and claims the benefit of priority of the prior Japanese Patent Application No. 2013-107502, filed on May 21, 2013, the entire contents of which are incorporated herein by reference.

### FIELD

The embodiments discussed herein are related to an optical receiver and slice level control method for discriminating received signal light using a slice level, and performing reception processing.

### BACKGROUND

In an optical communication system, an optical receiver receives signal light transmitted through an optical fiber transmission path. In the optical receiver, a light-receiving element such as an avalanche photodiode (APD) receives the signal light transmitted through the transmission path and converts the received signal light into a current signal and a preamplifier converts the current signal into a voltage signal and amplifies the voltage signal. A discriminator discriminately performs equalizing amplification with respect to the voltage signal and thereafter, a flip-flop (F/F) reproduces a voltage data signal. In this case, the discriminator uses the level (1/O) as a reference by comparing the magnitude of the voltage signal from the preamplifier and that of a predetermined slice level (see, e.g., Japanese Laid-Open Patent Publication Nos. 2002-141956, H8-265375, and H10-13396). The slice level is adjusted to be matched with, for example, an assumed counterpart optical transmitter and is delivered to the customer.

According to Japanese Laid-Open Patent Publication Nos. 2002-141956 and H8-265375, concerning the output signals of three discriminators that use slice levels different from that of one another, the output signal of the discriminator having the intermediate slice level is compared with each of the output signals of the two adjacent error-side discriminators. In a case where the results of the comparisons do not match, if the non-matching occurs in a direction opposite to the corresponding slice level, for example, in a direction to a larger level, the slice level of the intermediate discriminator is controlled by moving the three slice levels in a direction whereby the levels are decreased such that the slice level of the intermediate discriminator is positioned at a midpoint of two points at which the pseudo errors are equivalent.

According to Japanese Laid-Open Patent Publication No. H10-13396, the optical receiver includes two discriminators having a fixed potential difference therebetween and the discrimination points of the two discriminators simultaneously scan stepwise mutually maintaining the potential difference, and the number of output pulses of the exclusive OR of the discrimination results of the two discriminators is counted for a specific time period. A pseudo error rate is obtained from the number of output pulses and the counting time period, and the obtained pseudo error rate is determined to be an error rate that corresponds to either level of the two discrimination points. The discrimination point is controlled using an obtained error rate curve.

In high-speed, long-distance optical transmission, in a transmitted optical signal, degradation of the waveform (an increase of noise and waveform deformation) occurs consequent to slight differences in the transmission properties of the light sources and of the optical transmission paths (optical fibers and optical amplifiers). The state of the waveform deformation varies with time corresponding to the temperature variation of the optical transmission path.

For a conventional optical receiver, a fixed level is set to be the slice level, taking into consideration waveform degradation such that a bit error rate (BER) standard is satisfied under any condition. For example, an optical receiver is shipped for delivery after adjustment of the slice level and thereafter, is fixed at a level determined assuming a counterpart optical transmitter from the same manufacturer. In this manner, when the slice level is fixed at one point, it is hard to say that the slice level is optimally set for various waveform conditions. A situation may occur where the input optical signal has a significantly different waveform and a shift of the eye aperture position occurs at the input of the discriminator and therefore, no slice level is present that can satisfy the BER standard for each of the waveforms. As above, with the conventional optical receiver, a margin for an error is low and therefore, a problem arises in that the transmission distance and mutually connectable systems for the optical receiver are restricted.

For example, the techniques according to Japanese Laid-Open Patent Publication Nos. 2002-141956, H8-265375, and H10-13396 cannot cope with a case where the slopes of errors (BERs) on the “High (“1”)”-side and the “Low (“0”)”-side of the eye aperture are asymmetrical. When the slopes of the errors (BERs) on the “1”-side and the “0”-side are asymmetrical, the midpoint of two points at which the pseudo errors are equivalent is not an optimal point of the error rate and a problem arises in that the control point is set being deviated from the optimal setting position.

According to Japanese Laid-Open Patent Publication No. H10-13396, the actual error rate asymptotically approaches a higher level of the scanning on the “1”-side of the waveform and asymptotically approaches a lower level of the scanning on the “0”-side of the waveform. Therefore, when the error rate is regarded as the error rate of the higher level of the two discrimination points, the Low (“0”)-side of the error rate curve is shifted. When the error rate is regarded as the error rate of the lower level of the two discrimination points, the High (“1”)-side of the error rate curve is shifted. Therefore, a problem arises in that the actual control point is set being deviated from the optimal point.

An approach of executing error correction using error correction code (forward error correction: FEC) may be used to address the above problem. However, in a system to which FEC is not applied, when FEC is incorporated in an optical transmission and reception module, the size of the module increases. In particular, consequent to size restrictions, FEC cannot be incorporated into a small optical transmission and reception module such as that based on the 10 gigabit small form-factor pluggable transceiver multisource agreement (XFP MSA).

### SUMMARY

According to an aspect of an embodiment, an optical receiver includes a first discriminator in which an optimal point of a slice level is set and that compares a received signal to the slice level and discriminately outputs the received signal; a second discriminator that is connected in parallel to the first discriminator, compares the received signal to a slice level, and discriminately outputs the received signal; and a computing device that variably controls the slice level of the first and the second discriminators, respectively. The computing device executes a first process of setting the slice level of the first discriminator to be a predetermined slice level, calculating a pseudo error rate obtained when the slice level of the second discriminator is caused to variably scan, and setting the slice level of the first discriminator within a range in which the error rate does not vary.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an optical receiver according to a first embodiment;

FIGS. 2A and 2B are charts of pseudo BER computation results;

FIG. 3 is a chart of a computation result of a BER with for which a measuring time unit and error counts are reduced;

FIG. 4 is a chart of an example of a slice level optimal point derivation;

FIG. 5 is a flowchart of control to set a slice level according to the first embodiment;

FIG. 6 is a block diagram of the optical receiver according to a second embodiment;

FIG. 7 is a chart of an example of a slice level optimal point derivation according to the second embodiment;

FIG. 8 is a flowchart of control to set the slice level according to the second embodiment;

FIG. 9 is a block diagram of the optical receiver according to a third embodiment;

FIG. 10 is a chart of an example of an optimal point derivation for the slice level according to the third embodiment;

FIG. 11 is a flowchart of control to set the slice level according to the third embodiment;

FIG. 12 is a diagram of an example of optical waveforms of an optical signal and of input to a discriminator, for each light source;

FIG. 13 is a chart of examples of BER properties of the input to the discriminator based on the difference in the waveform between light sources;

FIG. 14 is a diagram of an example of a configuration of an optical transmission and reception module that includes the optical receiver; and

FIG. 15 is a diagram of an example of a configuration of a transmitting apparatus that includes plural optical transmission and reception modules.

### DESCRIPTION OF EMBODIMENTS

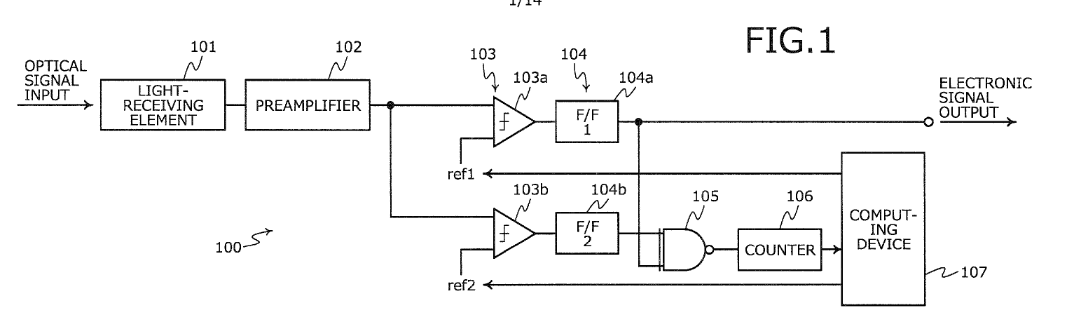

Embodiments will be described in detail with reference to the accompanying drawings. FIG. 1 is a block diagram of an optical receiver according to a first embodiment. The optical receiver 100 includes a light-receiving element 101, a preamplifier 102, discriminators 103, flip-flops (F/Fs) 104, an exclusive OR circuit 105, a counter 106, and a computing device 107.

The light-receiving element 101 receives signal light transmitted through a transmission path and converts the signal light into a current signal. An APD, etc. is used as the light-receiving element 101. The preamplifier 102 converts the current signal from the light-receiving element 101 into a voltage signal and amplifies the voltage signal. The voltage signal output by the preamplifier 102 is branched into two voltage signals and the discriminators 103 (first and second discriminators 103a and 103b) are disposed for the two voltage signals, parallel to one another.

The discriminators 103 (103a and 103b) each compares the magnitudes of the output of the preamplifier 102 with a predetermined slice level (ref), and discriminately performs equalizing amplification with respect to the output. The slice level of the discriminator 103a, which is for in-line use (and outputs the amplified signal as an electronic signal to an external destination and ultimately sets the optimal point of the slice level), will be denoted by “ref1” and the slice level of the discriminator 103b other than the discriminator 103a will be denoted by “ref2”.

The flip-flops (F/Fs) 104 (F/F1 (104a) and F/F2 (104b)) are respectively disposed downstream from the two discriminators 103 (103a and 103b) and respectively retain the output of the discriminators 103 (103a and 103b). The output of the F/F1 (104a) is output as an electronic signal to an external destination.

The exclusive OR circuit (NOR) 105 receives the output of the F/F1 (104a) and of the F/F2 (104b) and compares the outputs of the two F/Fs 104 (determines non-matching therebetween). The counter 106 counts the number of pulses of the output (the number of non-matching sessions) of the exclusive OR circuit 105. The computing device 107 computes a pseudo error rate based on the result output from the counter 106. The “pseudo” of the pseudo error rate means pseudo calculation (though not for the true value) in a state where the slice level of the discriminator 103a is not set at the optimal point (an initial setting state).

The computing device 107 is not limited to that configured only by circuit elements and may be configured using a processor such as a digital signal processor (DSP) or a central processing unit (CPU); memory such as read-only memory (ROM) or random access memory (RAM), etc. For example, the CPU executes control to set the optimal point of the slice level for the discriminator 103a by executing a control program stored in the ROM. For this control, the computing device 107 variably controls the slice levels ref1 and ref2 of the discriminators 103 (103a and 103b) (execution of processes 1 and 2 below).

In the embodiments, to obtain the true value of the BER, the computing device 107 executes processes 1 and 2 below. In process 1, the computing device 107 fixes the slice level of the first discriminator 103a at the slice level ref1, which is the initial setting thereof and causes the slice level ref2 of the second discriminator 103b to scan (vary) and thereby, sets the slice level of the first discriminator 103a to be within an error-free region (a flat region without any error and any fluctuation). In process 2, the computing device 107 obtains for the slice level ref1 of the initial setting of the first discriminator 103a, a relation between the slice level of the second discriminator 103b and the pseudo BER, and executes control to set, at the optimal point, the slice level ref1 of the first discriminator 103a such that the true BER is obtained.

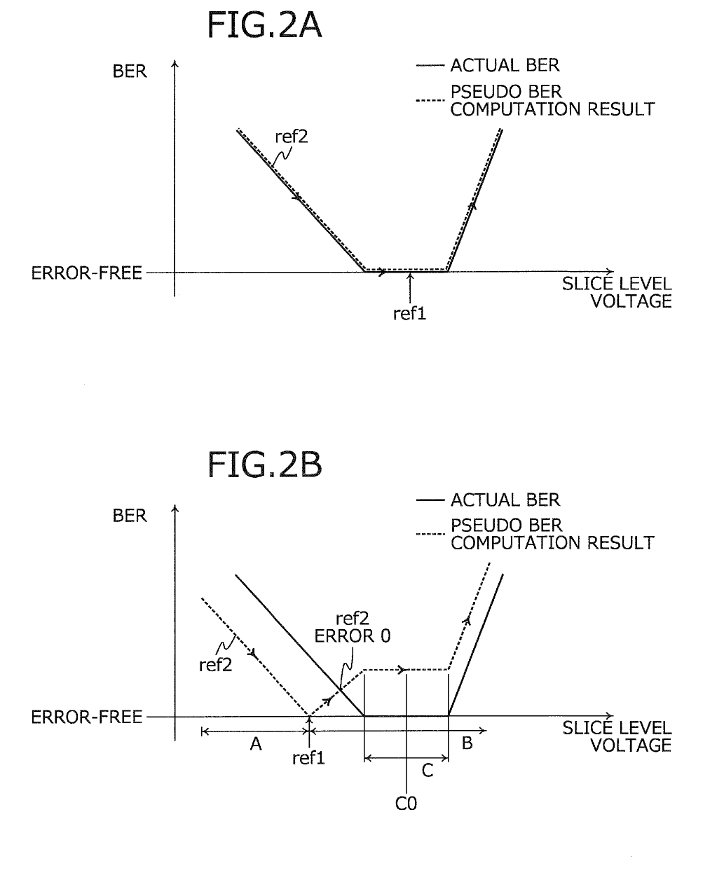

FIGS. 2A and 2B are charts of the pseudo BER computation results. The horizontal axes each represent the slice level voltage of the discriminators 103 and the vertical axes each represent the BER.

FIG. 2A depicts an example of a case where the slice level ref1 of the initial setting of the discriminator 103a is positioned within the error-free (flat) region. The BER is obtained based on the discrimination results for the slice level ref1 per unit measured time and the number of non-matching sessions of the discrimination results for the slice level ref2. As depicted in FIG. 2A, when the slice level ref1 of the initial setting is positioned within the error-free (flat) region, the number of errors is zero for the slice level ref1; therefore, the number of non-matching sessions is the number of errors for the slice level ref2 of the discriminator 103b; and therefore, the true BER can be obtained. The actual BER and the pseudo BER computation result are equal to each other. For the slice level ref2, as depicted, the computing device 107 varies the voltage of the discriminator 103b to scan the BER.

FIG. 2B depicts an example of a case where the slice level ref1 of the initial setting is not positioned within the error-free (flat) region. As depicted, a case is exemplified where the slice level ref1 is shifted toward the “0” level-side from the error free (flat) region. As depicted in FIG. 2B, when the slice level ref1 of the initial setting is not positioned within the error-free (flat) region, errors also occur for the slice level ref1 and therefore, in a region “A” where the slice level ref2 is lower than the slice level ref1, the actual errors for the slice level ref1 are cancelled out for the pseudo errors and are subtracted therefrom and therefore, the BER becomes lower than the actual BER. In the region A, the value on the counter of the discriminator 103b is decreased.

In a region B where the slice level ref2 is higher than the slice level ref1, the errors for the slice level ref1 are added to the pseudo errors and therefore, the BER becomes higher than the actual BER. In the region B, the value on the counter of the discriminator 103b is increased. When the slice level ref2 becomes equal to the slice level ref2 and the same errors occur for each of the slice levels ref1 and ref2: the pseudo errors are minimized; the pseudo BER is shifted from the actual BER; and therefore, the slice level cannot be controlled to be set at the optimal point.

Even in the case of FIG. 2B, in the actual error-free region, the number of actual errors is zero and does not vary for the slice level ref2 and therefore, the pseudo error does not vary. Consequently, it can be determined that this region C is the error-free (flat) region. Therefore, to obtain the true value of the BER as in FIG. 2A, in the initial scanning, the optimal point of the slice level ref1 is set at the center C0 of the region C for the pseudo error not to vary.

In this case, a case is assumed where no error-free region is present in the actual BER curve. In this case, the measuring time unit is reduced and the error count number is reduced. Thereby, an error-free region (the flat region) for the measuring time unit can be produced with which no error is counted in the measured time period.

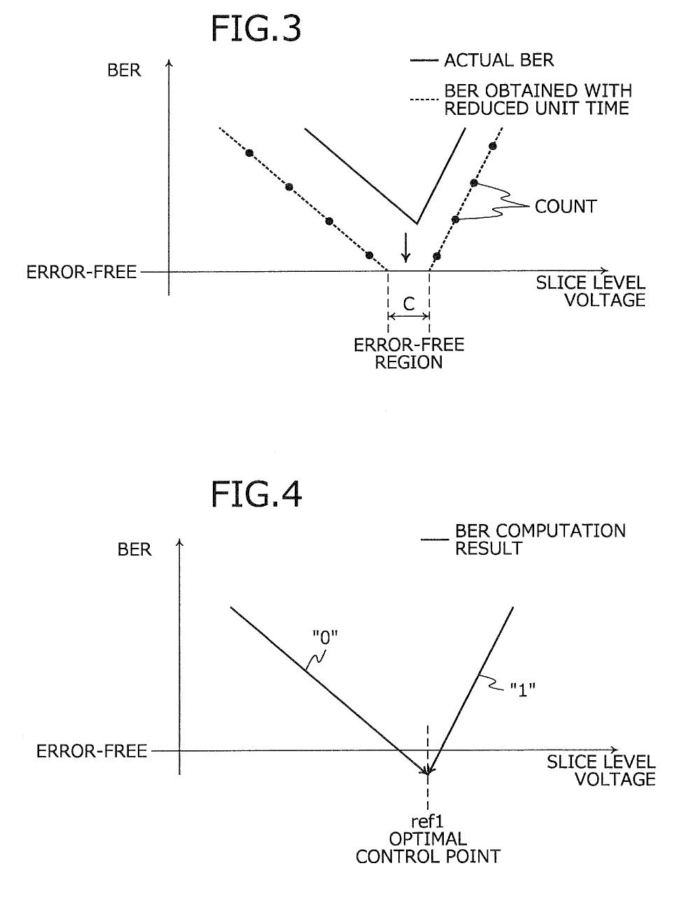

FIG. 3 is a chart of the computation result of the BER for which the measuring time unit and the error counts are reduced, and depicts a BER without any error-free region (a thick line) in the actual BER curve and the BER computed with the reduced measuring time unit and the reduced error counts (a dotted line). The BER can be computed when plural points are present on the dotted line.

The slice level ref1 is set in the error-free (flat) region C in the initial scanning and, thereafter, control is executed to set ref1 at the optimal slice level. Thereafter, to derive the optimal point of the slice level ref1, scanning of the slice level ref2 is recursively executed and BER curve information is recursively updated. In this case, the slice level ref1 is set in the error-free (flat) region and therefore, as depicted in FIG. 2A, the pseudo BER computation result is equal to the actual BER.

FIG. 4 is a chart of an example of a slice level optimal point derivation. The optimal slice level is the optimal point for the BER, that is, the point at which the BER is minimized. Thus, the slice level ref1 of the discriminator 103a can be set at an intersection (the optimal point) of the “1 (High)”-side BER curve and the “0 (Low)”-side BER curve from the graph obtained based on the pseudo BER computation result. In this case, even when the slopes of the BER curves on the High- and Low-sides are different from each other, the slice level ref1 can be set at the optimal point.

As depicted in FIG. 3, when no error-free region is present for the actual BER and control is executed with the reduced unit measured time, the BER curve is only offset toward the vertical axis (toward the BER axis) and therefore, no influence acts on the horizontal axis (the slice level voltage axis direction) and the obtained optimal slice level does not change.

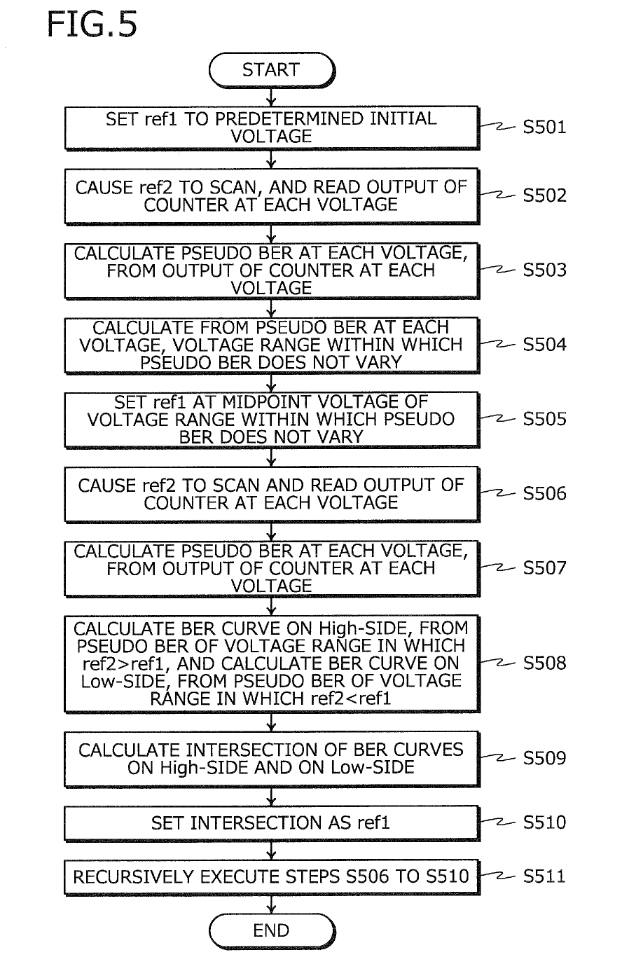

FIG. 5 is a flowchart of control to set the slice level according to the first embodiment. FIG. 5 depicts the control executed by the computing device 107. Process 1 (steps S501 to S505) corresponds to the details described with reference to FIG. 2. Process 2 (steps S506 to S510) corresponds to the details described with reference to FIG. 4.

The computing device 107 sets the slice level ref1 of the discriminator 103a at a predetermined initial voltage (step S501), causes the slice level ref2 of the discriminator 103b to scan (vary), and reads the output of the counter 106 at each voltage (step S502).

The computing device 107 calculates from the output of the counter 106 at each voltage, the pseudo BER at each voltage (step S503), calculates from the pseudo BER at each voltage, a voltage range (the region C) within which the pseudo BER does not vary (step S504), and sets the slice level ref1 of the discriminator 103a at the midpoint voltage (C0) of the voltage range (the region C) within which the pseudo BER does not vary (step S505).

Thereafter, the computing device 107 causes the slice level ref2 of the discriminator 103b to scan and reads the output of the counter 106 at each voltage (step S506), calculates the pseudo BER at each voltage, from the output of the counter 106 at each voltage (step S507), calculates the BER curve on the High (“1”)-side, from the pseudo BER of the voltage range in which the slice levels ref1 and ref2 is ref2>ref1, and calculates the BER curve on the Low (“0”)-side, from the pseudo BER of the voltage range in which the slice levels ref1 and ref2 is ref2<ref1 (step S508).

The computing device 107 calculates the intersection of the BER curves on the High-side and on the Low-side (step S509), sets the slice level ref1 of the discriminator 103a at this intersection (step S510), and thereafter, recursively executes the operations at steps S506 to S510 each time a predetermined time period elapses (step S511). Thereby, the variation of the waveform degradation over time can be coped with, such as variations consequent to temperature variations of the transmitter and the optical transmission path.

According to the first embodiment, the slice level of the discriminator can automatically be controlled; the optimal discrimination point can be set; and favorable BER properties can be obtained, notwithstanding the factors of the waveform degradation (the distribution of noise, and waveform degradation) in the field such as degradation consequent to the transmission path and slight differences in the signal waveform of each input signal.

A second embodiment is a configuration to execute the process of controlling the slice level in a shorter time period compared to that of the first embodiment. In the second embodiment, the speed is increased for the scanning of ref2 in the second and the later scanning sessions (the above process 2), which are for the control to set the slice level ref1 described in the first embodiment at the optimal slice level (the optimal point). Therefore, using further plural discriminators, plural F/Fs, plural exclusive OR circuits, and plural counters, the BERs are simultaneously computed for the slice levels including the slice level ref2 of the second discriminator 103b.

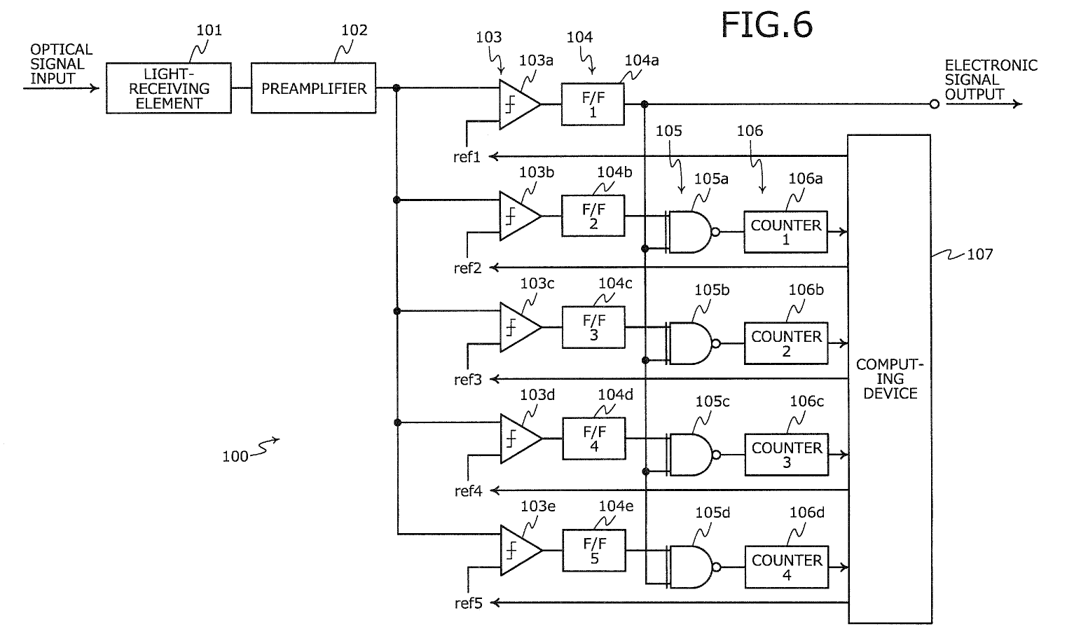

FIG. 6 is a block diagram of the optical receiver according to the second embodiment. The optical receiver does not execute the second and the later scanning sessions of ref2; and includes a total of four discriminators 103b to 103e of four different slice levels ref2 to ref5 including the discriminator 103b of the slice level ref2, and obtains the BERs at one time. Corresponding to the number of the discriminators 103b to 103e, the plural exclusive OR circuits 105 (105a to 105d), the plural counters 106 (106a to 106d) are disposed in the optical receiver, and the counters 106 (106a to 106d) output the respective count values to the computing device 107.

In the second embodiment, process 1 depicted in FIG. 2 is executed similarly to that of the first embodiment and the slice level ref1 of the discriminator 103a is set at the midpoint voltage (C0) of the voltage range within which the pseudo BER is not varied.

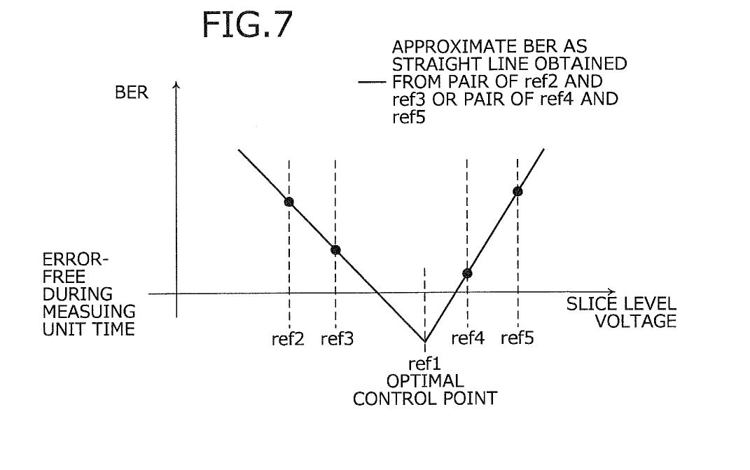

FIG. 7 is a chart of an example of a slice level optimal point derivation according to the second embodiment. A process will be described that substitutes process 2 (FIG. 4) described in the first embodiment. In the second embodiment, the computing device 107 obtains the BERs of the slice levels ref2 and ref3 on the Low (“0”)-side for the slice level ref1, and obtains the BER curve (an approximate curve) on the Low (“0”)-side of the BERs of the slice levels ref2 and ref3.

Similarly, the computing device 107 obtains the BERs of slice levels ref4 and ref5 on the High (“1”)-side for the slice level ref1, and obtains the BER curve (an approximate curve) on the High (“1”)-side based on the BERs of the slice levels ref4 and ref5. The computing device 107 sets the slice level ref1 of the discriminator 103a at the intersection of the BER curves on the Low (“0”)- and the High (“1”)-sides.

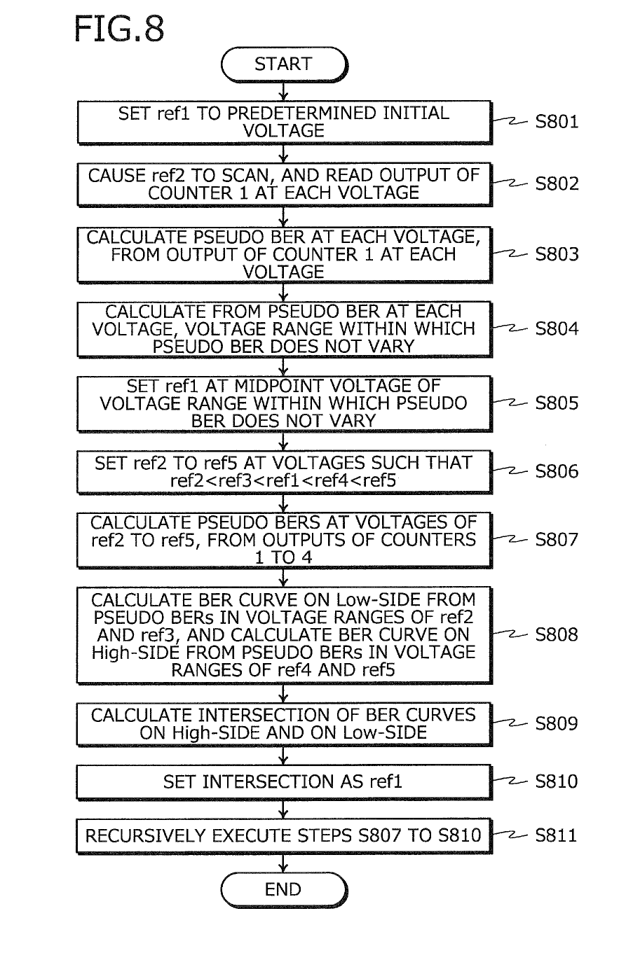

FIG. 8 is a flowchart of control to set the slice level according to the second embodiment and depicts the control executed by the computing device 107. Process 1 (steps S801 to S805) is same as the process including the process steps (steps S501 to S505) described in the first embodiment (FIG. 5) and therefore, will not again be described. The second embodiment differs from the first embodiment in that count values of the four counters (the counters 1 to 4) 106a to 106d are output to the computing device 107.

In process 2, at step S806, the computing device 107 sets the slice levels ref2 to ref5 of the discriminators 103b to 103e at voltages such that the slice levels are ref2<ref3<ref1<ref4<ref5 (step S806); and, thereafter, calculates the pseudo BERs at the voltages of the slice levels ref2 to ref5, from the outputs of the counters 1 (106a) to 4 (106d) (step S807).

The computing device 107 calculates the BER curve on the Low (“0”)-side from the pseudo BERs in the voltage ranges of the slice levels ref2 and ref3 obtained respectively based on the slice levels ref1 and ref2, and ref1 and ref3. Similarly, the computing device 107 also calculates the BER curve on the High (“1”)-side from the pseudo BERs in the voltage ranges of the slice levels ref4 and ref5 obtained respectively based on the slice levels ref1 and ref4, and ref1 and ref5 (step S808).

Thereafter, the computing device 107 calculates the intersection of the BER curves on the High (“1”)- and the Low (“0”)-sides (step S809), sets the intersection as the slice level ref1 of the discriminator 103a (step S810) and, thereafter, recursively executes the operations at steps S807 to S810 (step S811).

As depicted in FIG. 6, to calculate the BER curve by few settings of slice levels, the two different slice levels ref2 and ref3 are set on the Low (“0”)-side and the two different slice levels ref4 and ref5 are set on the High (“1”)-side. Setting more slice levels (the discrimination points) enables more precise calculation of the BER curve.

According to the second embodiment, similar to the first embodiment, the slice level of the discriminator can automatically be controlled, the optimal discrimination point can be set, and favorable BER properties can be obtained notwithstanding the factors of the degradation (the distribution of noise and waveform degradation) in the field such as degradation consequent to the transmission path and slight differences in the signal waveform of each input signal. Furthermore, in the second embodiment, the BERs at the plural points are simultaneously read and therefore, the slice level ref2 does not need to scan not like the first embodiment and the BER can be detected in a shorter time period than that of the first embodiment. Thus, the slice level can be controlled (set) to the optimal point at a high speed.

A third embodiment is a variation of the second embodiment and prevents the reduction of the signal amplitude consequent to branching the signal to the four discriminators 103 (103a to 103d) in the second embodiment. In addition, reduction of the circuit scale is facilitated compared to the second embodiment and an increase of the speed of the processing by the computing device 107 is facilitated compared to the first embodiment.

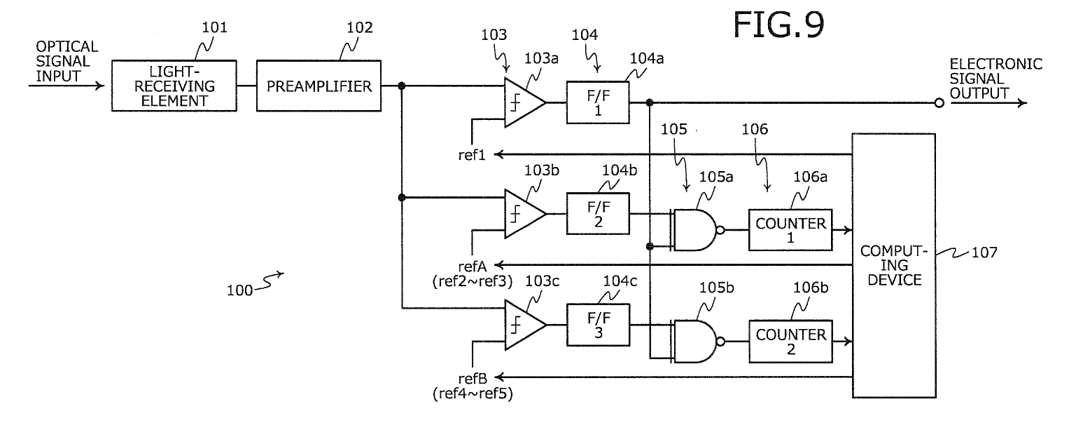

FIG. 9 is a block diagram of the optical receiver according to the third embodiment. If reductions in the signal amplitude consequent to branching is not allowed, a single discriminator 103b supporting the slice levels ref2 and ref3 and a single discriminator 103c supporting the slice levels ref4 and ref5 are disposed to reduce the number of signal branches to two. The slice level of the discriminator 103b is varied in a range of refA (between ref2 and ref3), the slice level of the discriminator 103c is varied in a range of refB (between ref4 and ref5), whereby the BERs for the slice levels for each variation are detected.

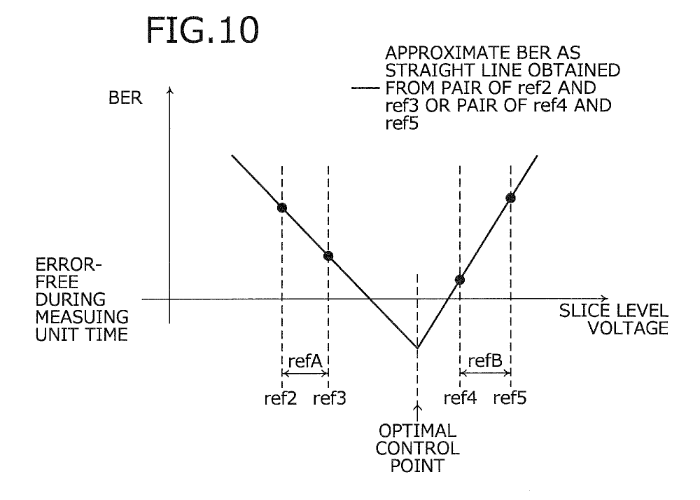

FIG. 10 is a chart of an example of an optimal point derivation for the slice level according to the third embodiment. In the third embodiment, the computing device 107 alternately varies the slice level refA of the discriminator 103b between ref2 and ref3; and alternately varies the slice level refB of the discriminator 103c between ref4 and ref5. For the slice level refA, though the two points ref2 and ref3 can be employed as minimum values, the detection precision of the BER curve can be improved by a continuous variation the slice level refA. The same holds for the slice level refB.

The computing device 107 obtains the BER curve on the Low (“0”)-side from the BERs at the levels of ref2 and ref3 obtained respectively from the slice levels ref1 and ref2, and ref1 and ref3; and, similarly, obtains the BER curve on the High (“1”)-side from the BERs at the levels of ref4 and ref5 obtained respectively from the slice levels ref1 and ref4, and ref1 and ref5. The computing device 107 sets the intersection of the BER curves on the High (“1”)- and the Low (“0”)-sides as the slice level ref1 of the discriminator 103a.

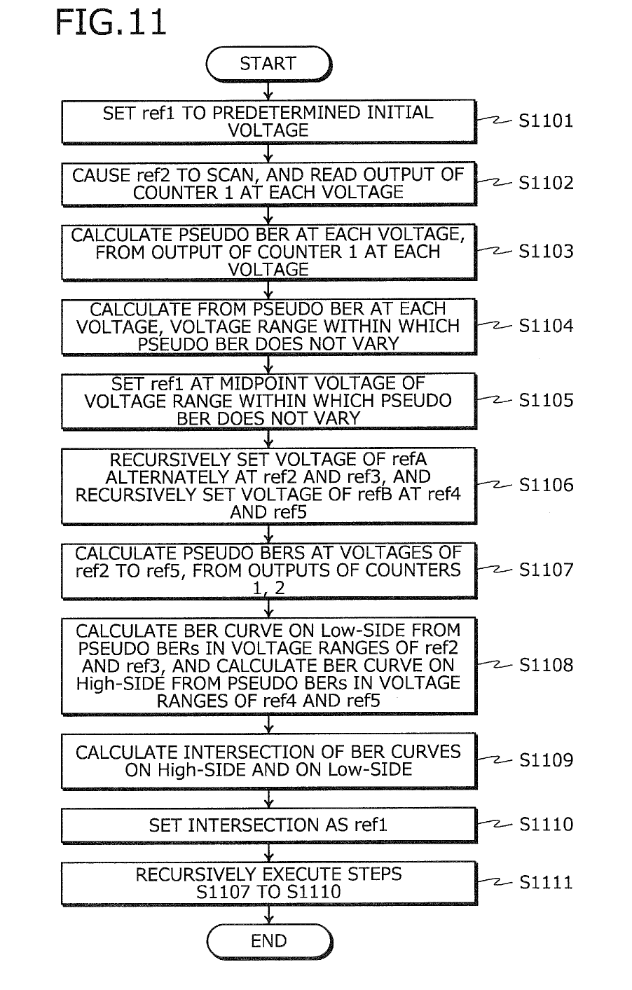

FIG. 11 is a flowchart of control to set the slice level according to the third embodiment and depicts the control executed by the computing device 107. Process 1 (steps S1101 to S1105) is the same as the process (steps S501 to S505) described in the first embodiment (FIG. 5) and therefore, will not again be described. The third embodiment differs from the above embodiments in that the number of signal branches is two and the count values of the two counters (the counters 1 and 2) 106a and 106b are output to the computing device 107.

For process 2, the computing device 107, at step S1106, recursively sets the voltage of the slice level refA of the discriminator 103b alternately at ref2 and ref3, and recursively sets the voltage of the slice level refB of the discriminator 103c alternately at ref4 and ref5 (step S1106). In this case, the slice levels are set at voltages such that the slice levels are ref2<ref3<ref1<ref4<ref5.

The computing device 107 calculates the pseudo BER at each of the voltages of the slice levels ref2 to ref5 from the outputs of the counters 1 and 2 (106a and 106b) (step S1107), calculates the BER curve on the Low (“0”)-side from the pseudo BERs in the voltage range of the slice levels ref2 and ref3, and similarly, calculates the BER curve on the High (“1”)-side from the pseudo BERs in the voltage range of the slice levels ref4 and ref5 (step S1108).

Thereafter, the computing device 107 calculates the intersection of the BER curves on the High (“1”)- and the Low (“0”)-sides (step S1109), sets the intersection as the slice level ref1 of the discriminator 103a (step S1110), and thereafter, recursively executes the operations at steps S1107 to S1110 (step S1111).

According to the third embodiment, similar to the first embodiment, the slice level of the discriminator can be controlled automatically, the optimal discrimination point can be set, and favorable BER properties can be obtained notwithstanding the factors of the degradation (the distribution of noise and waveform degradation) in the field such as degradation consequent to the transmission path and slight differences in the signal waveform of each input signal. Furthermore, not only one slice level (for example, ref2) but also two points (for example, ref2 and ref3) are caused to scan to calculate the BER in the third embodiment, whereby the BER can be detected in a shorter period of time than that of the first embodiment and the speed at which the optimal slice level (the discrimination point) can be controlled (set) is faster than that of the first embodiment. The number of signal branches can be reduced to a half of that of the second embodiment and therefore, signal amplitude smaller than that of the second embodiment can be coped with.

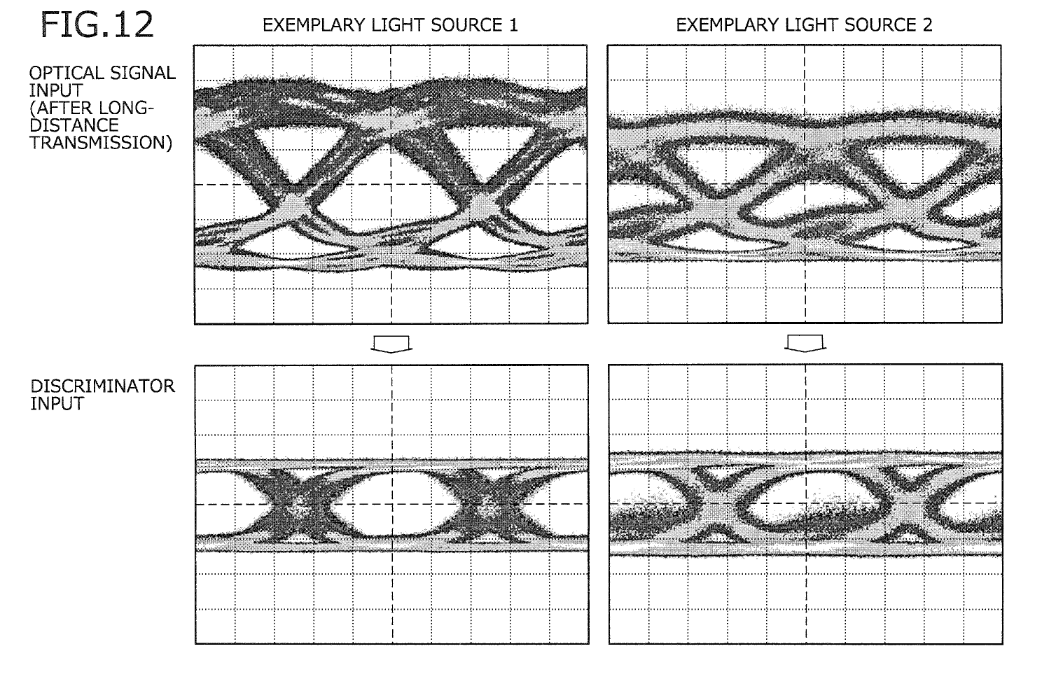

FIG. 12 is a diagram of an example of optical waveforms of the optical signal and of the input to the discriminator, for each light source. The waveforms of the optical signal inputs (after long-distance transmission) differ for exemplary light sources 1 and 2 and therefore, a difference is generated between the inputs to the discriminators. As above, transmission waveforms slightly differ depending on the type (including the manufacturer) of the light source of the transmitter, transmission path properties, etc.

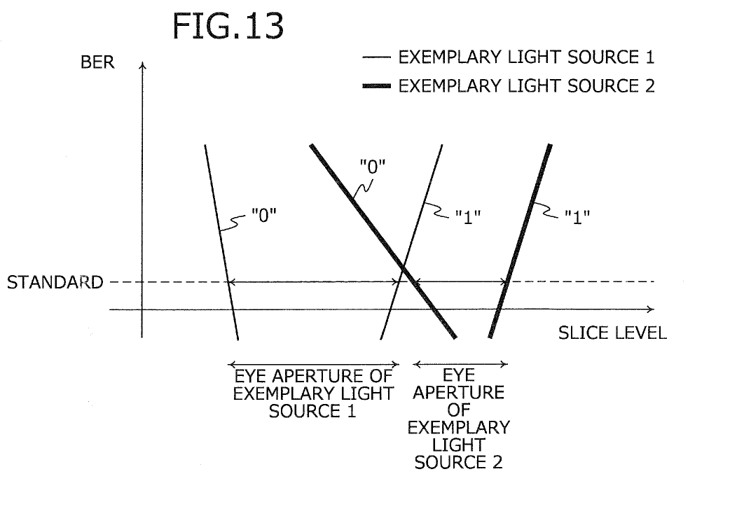

FIG. 13 is a chart of examples of BER properties of the input to the discriminator based on the difference in the waveform between the light sources. The horizontal axis represents the slice level of the discriminator (the eye aperture direction) and the vertical axis represents the BER. The optimal point cannot be set even when the fixed slice level is attempted to be set such that the BER standard is satisfied under any condition taking into consideration the waveform degradation of each of exemplary light sources 1 and 2 depicted in FIG. 12. The waveform of the optical signal input significantly differs between the exemplary light sources 1 and 2 depicted in FIG. 13 and therefore, the eye aperture positions for the discriminator input are shifted (in the example of FIG. 12, the eye apertures do not overlap with each other). Therefore, no slice level is present that satisfies the BER standard for each of the waveforms. In the case where the slopes of the BER curves on the Low (“0”)- and the High (“1”)-sides of the eye aperture are different from each other (asymmetrical), when the slice level is simply set at the midpoint of the pair of BER curves, the discrimination point may not be optimal.

In contrast, in the embodiment, the optimal range (“C” in FIG. 2B) is obtained within which the discrimination point is set by process 1 and that can cope with the optical signal input (after long-distance transmission) for any light source and any transmission property. Even when the slops of the BER curves are different from each other, the optimal discrimination point can be found from the BER curves on the Low (“0”)- and the High (“1”)-sides by process 2 and can be set in the discriminator 103 (103a).

As above, according to the embodiment, coping with the dispersion of the signal waveforms of the input signals and various factors of the degradation (the distribution of noise and waveform degradation) in the field, the slice level of the discriminator is automatically varied by executing the pseudo error detection, without using error correction code (FEC). Thereby, the fluctuation of the signal waveform of the input signal is followed and, even when the error slopes on the High (“1”)- and the Low (“0”)-sides are asymmetrical, the optimal BER property can be obtained.

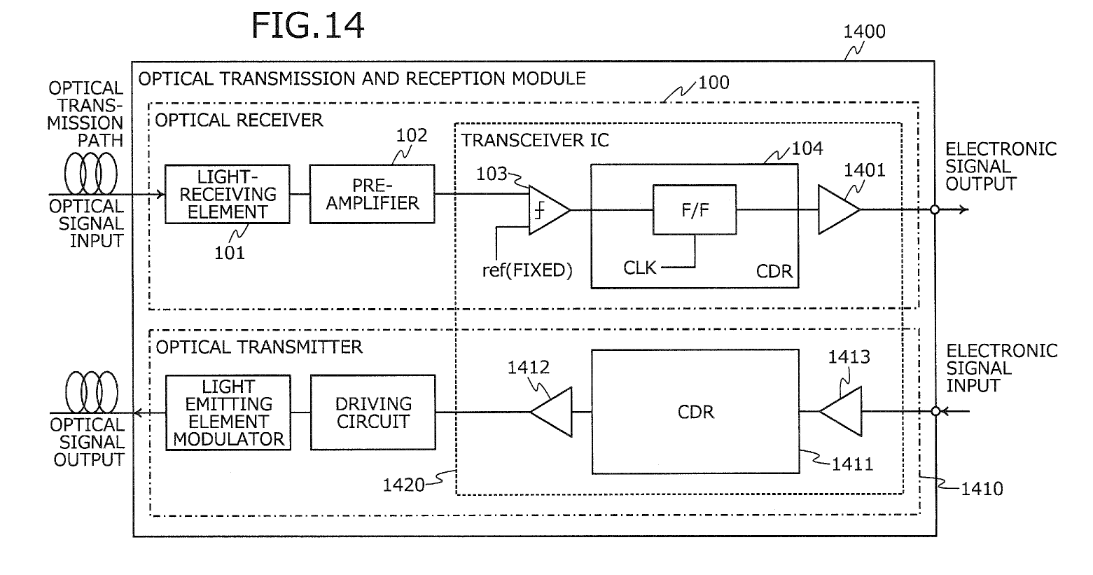

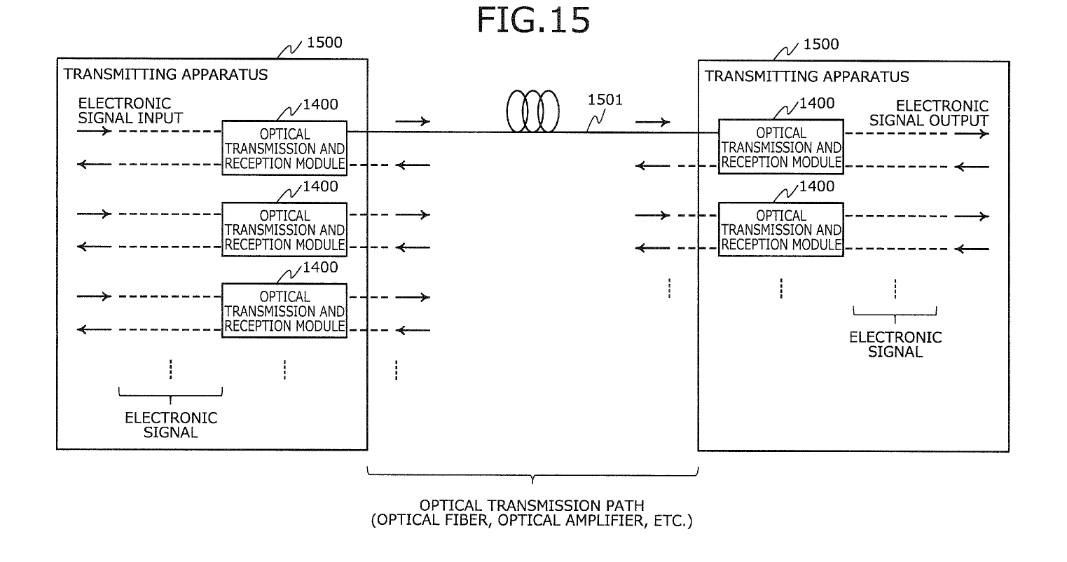

FIG. 14 is a diagram of an example of a configuration of the optical transmission and reception module that includes the optical receiver. FIG. 15 is a diagram of an example of a configuration of a transmitting apparatus that includes plural optical transmission and reception modules. As depicted in FIG. 14, the optical transmission and reception module 1400 includes the optical receiver 100 and an optical transmitter 1410. Components are integrated with each other as a transceiver 1420 such as the discriminator 103, the F/F (clock data recovery: CDR) 104, and an output driving circuit 1401, of the optical receiver 100; and a CDR 1411, a discriminator 1412 upstream thereof, and an output driving circuit 1413 downstream thereof, of the optical transmitter 1410.

In the optical receiver 100 included in the transceiver 1420, the discriminator 103, which sets the slice level of the received optical signal, corresponds to the discriminator 103a. Although not depicted in detail in FIG. 14, the optical transmission and reception module 1400 includes the plural discriminators 103 (103a to 103e), the plural F/Fs 104 (104a to 104e), the plural exclusive OR circuits 105 (105a to 105d), the plural counters 106 (106a to 106d), and the computing device 107 that are described in the first to the third embodiments. The CPU, etc. configuring the computing device 107 may have the functions of the CDRs 104 and 1411.

According to the optical transmission and reception module configured as described, FEC does not need to be included and therefore, increases in module size can be prevented. Consequently, the optical transmission and reception module 1400 can be incorporated in a small-size module such as an XFP. Thereby, the plural optical transmission and reception modules 1400 each satisfying the module (size) standard such as the XFP and each including the discriminator 103a capable of having the optimal discrimination point set therein, can be disposed in a transmitting apparatus 1500 connected by an optical transmission path 1501 as depicted in FIG. 15.

According to the embodiments, the slice level can be controlled automatically in the receiver such that the BER becomes optimal regardless of the input signal optical waveform, which is affected by differences in the light sources, the transmission distance, etc. The slice level can be set at the optimal point without using any error correction code and therefore, downsizing is facilitated for the transmitter and the optical module including the transmitter and the receiver. The receiver flexibly copes with incompatibility (inoperability) among the module venders (the manufacturers) and/or incompatibility with an optical module that is based on another platform of an existing system. As a result, the optimal BER property can always be obtained and restrictions on the system concerning mutual connections are reduced. Thus, the range of the applications of the system can be expanded.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical receiver comprising:
a first discriminator in which an optimal point of a slice level is set and that compares a received signal to the slice level and discriminately outputs the received signal;
a second discriminator that is connected in parallel to the first discriminator, compares the received signal to a slice level, and discriminately outputs the received signal; and
a computing device that variably controls the slice level of the first and the second discriminators, respectively, wherein
the computing device executes a first process of setting the slice level of the first discriminator to be a predetermined slice level, calculating a pseudo error rate obtained when the slice level of the second discriminator is caused to variably scan, and setting the slice level of the first discriminator within a range in which the error rate does not vary.

2. The optical receiver according to claim 1, wherein
the computing device sets the slice level of the first discriminator at a midpoint of the range in which the error rate does not vary.

3. The optical receiver according to claim 1, wherein
the computing device sets the slice level of the first discriminator to be in the range in which the error rate does not vary, compares output logic of the first and the second discriminators, and computes the error rate.

4. The optical receiver according to claim 1, wherein
the computing device executes a second process of calculating a pair of property curves representing variations of the error rate against a variation of the slice level on a “0”-level and a “1”-level sides of an eye aperture of the received signal, based on a result of discrimination by the first discriminator for which the slice level is set at a midpoint of the range in which the error rate does not vary, and a result of discrimination obtained by the second discriminator when the slice level thereof is caused to variably scan, and calculating the optimal point of the slice level for the first discriminator, based on the pair of property curves of the error rate.

5. The optical receiver according to claim 4, wherein
the computing device sets an intersection of the pair of property curves of the error rate as the optimal point of the slice level of the first discriminator.

6. The optical receiver according to claim 1, further comprising:
an exclusive OR circuit that detects non-matching between the outputs of the first and the second discriminators; and
a counter that counts pulses of the output of the exclusive OR circuit, wherein
the computing device computes the pseudo error rate based on a result output by the counter, and detects the range in which the error rate does not vary, based on a result of voltage-variable scanning of the slice level of the second discriminator.

7. The optical receiver according to claim 1, wherein
the second discriminator comprises a plurality of discriminators each having set therein a predetermined slice level that differs for each discriminator and has, as a center, an initial slice level set in the first discriminator, wherein
the optical receiver further comprises:
a plurality of exclusive OR circuits that detect non-matching between an output of the first discriminator and an output of each of the second discriminators, respectively; and
a plurality of counters that count pulses of the exclusive OR circuits, respectively, and
the computing device, after executing a first process, executes a third process of calculating a pair of property curves representing variations of the error rate against a variation of the slice level on a “0”-level and a “1”-level sides of an eye aperture of the received signal, based on a result of discrimination by the first discriminator for which the slice level is set at a midpoint of the range in which the error rate does not vary, and results output by the counters, and calculating the optimal point of the slice level for the first discriminator, based on the pair of property curves of the error rate.

8. The optical receiver according to claim 1, wherein
the second discriminator comprises a plurality of discriminators each having set therein a predetermined slice level that differs for each discriminator and has, as a center, an initial slice level set in the first discriminator, wherein
the optical receiver further comprises:
a plurality of exclusive OR circuits that detect non-matching between an output of the first discriminator and an output of each of the second discriminators, respectively; and
a plurality of counters that count pulses of the exclusive OR circuits, respectively, and
the computing device, after executing a first process, executes a fourth process of calculating a pair of property curves representing variations of the error rate against a variation of the slice level on a “0”-level and a “1”-level sides of an eye aperture of the received signal, based on a result of discrimination by the first discriminator for which the slice level is set at a midpoint of the range in which the error rate does not vary, and a result of discrimination obtained by the second discriminator when the slice level thereof is caused to variably scan in a predetermined range, and calculating the optimal point of the slice level for the first discriminator, based on the pair of property curves of the error rate.

9. The optical receiver according to claim 1, further comprising:
a light-receiving element that opto-electronically converts into the received signal, an optical signal transmitted in a transmission path; and
a preamplifier that amplifies the received signal of the light-receiving element.

10. An optical transmission and reception module comprising:
the optical receiver according to claim 1; and
an optical transmitter.

11. The optical transmission and reception module according to claim 10, wherein
the optical transmission and reception module complies with a predetermined module standard.

12. A transmission apparatus comprising, in plural, the optical transmission and reception modules according to claim 11 and complying with the predetermined module standard.

13. A slice level control method of setting an optimal point of a slice level for a first discriminator of an optical receiver that includes the first discriminator that compares a received signal to the slice level and discriminately outputs the received signal; a second discriminator that is connected in parallel to the first discriminator, compares the received signal to a slice level, and discriminately outputs the received signal; and
a computing device that variably controls the slice level of the first and the second discriminators, respectively, the slice level control method comprising:
executing, by the computing device, a first process of:
setting the slice level of the first discriminator to be a predetermined slice level,
calculating a pseudo error rate obtained when the slice level of the second discriminator is caused to variably scan, and
setting the slice level of the first discriminator within a range in which the error rate does not vary.

14. The slice level control method according to claim 13, further comprising
executing, by the computing device and after execution of the first process, a second process of:
calculating a pair of property curves representing variations of the error rate against a variation of the slice level on a “0”-level and a “1”-level sides of an eye aperture of the received signal, based on a result of discrimination by the first discriminator for which the slice level is set at a midpoint of the range in which the error rate does not vary, and a result of discrimination obtained by the second discriminator when the slice level thereof is caused to variably scan, and
calculating the optimal point of the slice level for the first discriminator, based on the pair of property curves of the error rate.

15. The slice level control method according to claim 14, wherein
the computing device recursively executes the second process each time a predetermined time period elapses.
